(19) United States
(12) Patent Application Publication
(10) Pub. No.: US 2006/0078683 A1
(43) Pub. Date: Apr. 13, 2006

(54) Multilayered structure film and method of making the same

(75) Inventor: Ryoichi Mukai, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/285,254

(22) Filed: Nov. 22, 2005

Related U.S. Application Data
(63) Continuation of application No. PCT/JP03/08756, filed on Jul. 10, 2003.

(51) Int. Cl. G11B 5/66; B05D 5/12; B05D 1/36

(52) U.S. Cl. 427/402; 428/831.2; 428/836.1; 427/127

(57) ABSTRACT

A first group of atoms is first deposited for forming a multilayered structure film. The atoms are subjected to heat treatment to form a first polycrystalline layer. A second group of atoms is deposited on the surface of the first polycrystalline layer so as to form a second polycrystalline layer having a thickness larger than the thickness of the first polycrystalline layer. A third group of atoms is deposited on the surface of the second polycrystalline layer so as to form a magnetic polycrystalline layer. The method enables a reliable prevention of migration of atoms in the first group during the deposition of the first group. This enables establishment of fine and uniform crystal grains in the first polycrystalline layer. Migration can still be suppressed during the deposition of the second group. Fine and uniform crystal grains can thus be established in the second polycrystalline layer.

### BACKGROUND OF THE INVENTION

1. Field of the Invention

The present invention relates to a multilayered structure film often utilized in a magnetic recording medium such as a hard disk (HD), for example.

2. Description of the Prior Art

A magnetic recording medium such as a hard disk, HD, usually includes a polycrystalline underlayer extending by a constant thickness over the surface of a substrate and a polycrystalline intermediate layer extending by a constant thickness over the surface of the polycrystalline underlayer. The polycrystalline intermediate layer contains a non-magnetic element such as Cr. A magnetic polycrystalline layer extends over the surface of the polycrystalline intermediate layer. Grain boundaries are formed between the adjacent magnetic crystal grains in the magnetic polycrystalline layer. Non-magnetic atoms such as Cr atoms come out of the polycrystalline intermediate layer into the magnetic polycrystalline layer along the grain boundaries. The non-magnetic atoms thus serve to establish non-magnetic walls along the grain boundaries in the magnetic polycrystalline layer.

Sputtering is employed for forming the polycrystalline underlayer, the polycrystalline intermediate layer and the magnetic polycrystalline layer. Material of the polycrystalline underlayer, the polycrystalline intermediate layer or the magnetic polycrystalline layer is deposited on the heated substrate until the layer reaches a predetermined thickness. The heat of the substrate causes crystal grains to irregularly accrete in the polycrystalline intermediate layer. This results in enlargement of the crystal grains.

### SUMMARY OF THE INVENTION

It is accordingly an object of the present invention to provide a multilayered structure film contributing to establishment of finer crystal grains in a polycrystalline intermediate layer and a method of making the multilayered structure film.

According to a first aspect of the present invention, there is provided a method of making a multilayered structure film, comprising: depositing a first group of atoms on the surface of an object; subjecting the first group of atoms to heat treatment so as to form a first non-magnetic polycrystalline layer; depositing a second group of atoms on the surface of the first non-magnetic polycrystalline layer so as to form a second non-magnetic polycrystalline layer having a thickness larger than the thickness of the first non-magnetic polycrystalline layer, said second group of atoms including atoms of at least one element contained in the first non-magnetic polycrystalline layer; depositing a third group of atoms on the surface of the second non-magnetic polycrystalline layer so as to form a magnetic polycrystalline layer, said third group of atoms including atoms of at least one non-magnetic element contained in the second non-magnetic polycrystalline layer; and subjecting at least the second non-magnetic polycrystalline layer and the magnetic polycrystalline layer to heat treatment.

The method enables a reliable prevention of migration of atoms in the first group during the deposition of the first group of atoms. The deposition in a thickness significantly smaller than the overall thickness of the multilayered structure film enables establishment of fine and uniform crystal grains in the first non-magnetic polycrystalline layer after the heat treatment. The second group of atoms is thereafter deposited on the surface of the first non-magnetic polycrystalline layer until attainment of a sufficient thickness. Migration can still be suppressed during the deposition of the second group. Fine and uniform crystal grains can thus be established in the second non-magnetic polycrystalline layer. Enlargement of the crystal grains can reliably be avoided.

Atoms of a non-magnetic element move out of the second non-magnetic polycrystalline layer into the magnetic polycrystalline layer along the grain boundaries in response to the heat treatment to the second non-magnetic polycrystalline layer and the magnetic polycrystalline layer. This results in establishment of the walls of the non-magnetic element along the grain boundaries in the magnetic polycrystalline layer. The wall serves to reliably suppress magnetic interaction between the adjacent magnetic crystal grains in the magnetic polycrystalline layer.

The first, second and third group of atoms may exist as an alloy containing Co and Cr in the method. A vacuum condition may be kept during a period from the deposition of the first group of atoms until the completion of the heat treatment to the second non-magnetic polycrystalline layer and the magnetic polycrystalline layer.

The method serves to provide a multilayered structure film comprising: a non-magnetic polycrystalline underlayer; a first non-magnetic polycrystalline intermediate layer including crystal grains adjacent to each other on the surface of the non-magnetic polycrystalline underlayer; a second non-magnetic polycrystalline intermediate layer containing at least one element contained in the first non-magnetic polycrystalline intermediate layer, said second non-magnetic polycrystalline intermediate layer extending over the surface of the first non-magnetic polycrystalline intermediate layer by a thickness larger than the thickness of the first non-magnetic polycrystalline intermediate layer, the second non-magnetic polycrystalline intermediate layer including crystal grains individually having grown from the corresponding crystal grains of the first non-magnetic polycrystalline intermediate layer; and a magnetic polycrystalline layer including crystal grains adjacent to each other on the surface of the second non-magnetic polycrystalline intermediate layer, said magnetic polycrystalline layer containing at least one non-magnetic element contained in the second non-magnetic polycrystalline intermediate layer. The multilayered structure layer enables establishment of the walls of a non-magnetic element along the grain boundaries in the magnetic polycrystalline layer. The wall serves to reliably suppress magnetic interaction between the adjacent magnetic crystal grains in the magnetic polycrystalline layer.

In this case, the magnetic polycrystalline layer may comprise: a first magnetic polycrystalline layer including crystal grains adjacent to each other on the surface of the second non-magnetic polycrystalline intermediate layer; and a second magnetic polycrystalline layer containing at least one element contained in the first magnetic polycrystalline layer, said second magnetic polycrystalline layer extending over the surface of the first magnetic polycrystalline layer by a thickness larger than the thickness of the first magnetic polycrystalline layer. Here, the second magnetic polycrystalline layer may include crystal grains individually having grown from the corresponding crystal grains of the first magnetic polycrystalline layer. The first and second magnetic polycrystalline layers are allowed to have a sufficient thickness regardless of the establishment of the fine crystal grains. The first and second polycrystalline intermediate layers as well as the first and second magnetic polycrystalline layers may be made of an alloy containing Co and Cr, for example.

The non-magnetic polycrystalline underlayer may comprise: a first non-magnetic polycrystalline underlayer including crystal grains adjacent to each other; and a second non-magnetic polycrystalline underlayer containing at least one element contained in the first non-magnetic polycrystalline underlayer, said second non-magnetic polycrystalline underlayer extending over the surface of the first non-magnetic polycrystalline underlayer by a thickness larger than the thickness of the first non-magnetic polycrystalline underlayer. Here, the second non-magnetic polycrystalline underlayer may include crystal grains individually having grown from the corresponding crystal grains of the first non-magnetic polycrystalline underlayer. Fine and uniform crystal grains are established in the first and second non-magnetic polycrystalline underlayers. The first and second polycrystalline underlayers may respectively be made of Ti, for example.

According to a second aspect of the present invention, there is provided a method of making a multilayered structure film, comprising: depositing a first group of atoms on the surface of an object; subjecting the first group of atoms to heat treatment so as to form a first non-magnetic polycrystalline layer; depositing a second group of atoms on the surface of the first non-magnetic polycrystalline layer so as to form a second non-magnetic polycrystalline layer having a thickness larger than the thickness of the first non-magnetic polycrystalline layer, said second group of atoms including atoms of at least one element contained in the first non-magnetic polycrystalline layer; depositing a third group of atoms on the surface of the second non-magnetic polycrystalline layer so as to form a first magnetic polycrystalline layer, said third group of atoms including atoms of at least one non-magnetic element contained in the second non-magnetic polycrystalline layer; depositing a fourth group of atoms on the surface of the first magnetic polycrystalline layer; subjecting the fourth group of atoms to heat treatment so as to form a third non-magnetic polycrystalline layer; depositing a fifth group of atoms on the surface of the third non-magnetic polycrystalline layer so as to form a fourth non-magnetic polycrystalline layer having a thickness larger than the thickness of the third non-magnetic polycrystalline layer, said fifth group of atoms including atoms of at least one element contained in the third non-magnetic polycrystalline layer; depositing a sixth group of atoms on the surface of the fourth non-magnetic polycrystalline layer so as to form a second magnetic polycrystalline layer, said sixth group of atoms including atoms of at least one non-magnetic element contained in the fourth non-magnetic polycrystalline layer; and subjecting at least the fourth non-magnetic polycrystalline layer and the second magnetic polycrystalline layer to heat treatment.

The method enables a reliable prevention of migration of the atoms in the first group during the deposition of the first group of atoms in the same manner as described above. The deposition in a thickness significantly smaller than the overall thickness of the multilayered structure film enables establishment of fine and uniform crystal grains in the first non-magnetic polycrystalline layer after the heat treatment. The second group of atoms is thereafter deposited on the surface of the first non-magnetic polycrystalline layer until attainment of a sufficient thickness. Migration can still be suppressed during the deposition of the second group. Fine and uniform crystal grains can thus be established in the second non-magnetic polycrystalline layer. Enlargement of the crystal grains can reliably be avoided. The method also enables a reliable prevention of migration of atoms in the third and fifth groups during the deposition of the third and fifth groups of atoms in the same manner.

The second non-magnetic polycrystalline layer and the first magnetic polycrystalline layer are subjected to heat during the heat treatment to the fourth group of atoms. Atoms of a non-magnetic element move out of the second non-magnetic polycrystalline layer into the first magnetic polycrystalline layer along the grain boundaries. This results in establishment of the walls of a non-magnetic element along the grain boundaries in the first magnetic polycrystalline layer. The wall serves to reliably suppress magnetic interaction between the adjacent magnetic grains in the first magnetic polycrystalline layer. Likewise, atoms of a non-magnetic element move out of the second non-magnetic polycrystalline layer into the first and second magnetic polycrystalline layers along the grain boundaries in response to the heat treatment to the second non-magnetic polycrystalline layer and the first and second magnetic polycrystalline layers. This results in establishment of the walls of a non-magnetic element along the grain boundaries in the second magnetic polycrystalline layer. The wall serves to reliably suppress magnetic interaction between the adjacent magnetic grains in the second magnetic polycrystalline layer.

The first to sixth group of atoms may exist as an alloy containing Co and Cr in the method, for example. A vacuum condition may be kept during a period from the deposition of the first group of atoms until the completion of the heat treatment to the fourth non-magnetic polycrystalline layer and the second magnetic polycrystalline layer.

The method serves to provide a multilayered structure film comprising: a non-magnetic polycrystalline underlayer; a first non-magnetic polycrystalline intermediate layer including crystal grains adjacent to each other on the surface of the non-magnetic polycrystalline underlayer; a second non-magnetic polycrystalline intermediate layer containing at least one element contained in the first non-magnetic polycrystalline intermediate layer, said second non-magnetic polycrystalline intermediate layer extending over the surface of the first non-magnetic polycrystalline intermediate layer by a thickness larger than the thickness of the first non-magnetic polycrystalline intermediate layer, the second non-magnetic polycrystalline intermediate layer including crystal grains individually having grown from the corresponding crystal grains of the first non-magnetic polycrystalline intermediate layer; a lower magnetic polycrystalline layer including crystal grains adjacent to each other on the surface of the second non-magnetic polycrystalline intermediate layer, said lower magnetic polycrystalline layer containing at least one non-magnetic element contained in the second non-magnetic polycrystalline intermediate layer; a first non-magnetic polycrystalline layer including crystal grains adjacent to each other on the surface of the lower magnetic polycrystalline layer; a second non-magnetic polycrystalline layer containing at least one element contained in the first non-magnetic polycrystalline layer, said second non-magnetic polycrystalline layer extending over the surface of the first non-magnetic polycrystalline layer by a thickness larger than the thickness of the first non-magnetic polycrystalline layer, the second non-magnetic polycrystalline layer including crystal grains individually having grown from the corresponding crystal grains of the first non-magnetic polycrystalline layer; and an upper magnetic polycrystalline layer including crystal grains adjacent to each other on the surface of the second non-magnetic polycrystalline layer, said upper magnetic polycrystalline layer containing at least one non-magnetic element contained in the second non-magnetic polycrystalline layer. The multilayered structure layer enables establishment of the walls of a non-magnetic element along the grain boundaries in the lower and upper magnetic polycrystalline layers in the aforementioned manner. The wall serves to reliably suppress magnetic interaction between the adjacent magnetic grains in the lower and upper magnetic polycrystalline layers.

The lower and upper magnetic polycrystalline layers may respectively comprise: a first magnetic polycrystalline layer including crystal grains adjacent to each other; and a second magnetic polycrystalline layer containing at least one element contained in the first magnetic polycrystalline layer, said second magnetic polycrystalline layer extending over the surface of the first magnetic polycrystalline layer by a thickness larger than the thickness of the first magnetic polycrystalline layer. Here, the second magnetic polycrystalline layer may include crystal grains individually having grown from the corresponding crystal grains of the first magnetic polycrystalline layer. The first and second magnetic polycrystalline layers are allowed to have a sufficient thickness regardless of the establishment of the fine and uniform crystal grains as described above. The first and second polycrystalline intermediate layers, the first and second magnetic polycrystalline layers, and the first and second non-magnetic polycrystalline layers may be made of an alloy containing Co and Cr, for example.

The multilayered structure film may be utilized for a magnetic recording medium such as a magnetic recording disk. In this case, the magnetic recording medium may comprise: a substrate; a non-magnetic polycrystalline underlayer extending over the surface of the substrate; a first non-magnetic polycrystalline intermediate layer including crystal grains adjacent to each other on the surface of the non-magnetic polycrystalline underlayer; a second non-magnetic polycrystalline intermediate layer containing at least one element contained in the first non-magnetic polycrystalline intermediate layer, said second non-magnetic polycrystalline intermediate layer extending over the surface of the first non-magnetic polycrystalline intermediate layer by a thickness larger than the thickness of the first non-magnetic polycrystalline intermediate layer, the second non-magnetic polycrystalline intermediate layer including crystal grains individually having grown from the corresponding crystal grains of the first non-magnetic polycrystalline intermediate layer; and a magnetic polycrystalline layer extending over the surface of the second non-magnetic polycrystalline intermediate layer, said magnetic polycrystalline layer containing at least one non-magnetic element contained in the second non-magnetic polycrystalline intermediate layer.

The magnetic recording medium enables establishment of the walls of a non-magnetic element along the grain boundaries in the magnetic polycrystalline layer. The wall serves to reliably suppress magnetic interaction between the adjacent magnetic crystal grains in the magnetic polycrystalline layer. This results in a sufficient reduction in the transition noise in reading magnetic information data.

The aforementioned magnetic recording medium may be a so-called perpendicular magnetic recording medium, for example. The axis of easy magnetization may be aligned in the vertical direction perpendicular to the surface of the substrate in the aforementioned magnetic polycrystalline layer and the first and second magnetic polycrystalline layers. The perpendicular magnetic recording medium may further comprise: a non-magnetic polycrystalline layer receiving the non-magnetic polycrystalline underlayer; and a magnetic underlayer defining a surface receiving the non-magnetic polycrystalline layer, said magnetic underlayer having an axis of easy magnetization in a direction parallel to the surface of the magnetic underlayer.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a plan view schematically illustrating the structure of a hard disk drive, HDD, as an example of a magnetic recording medium drive or storage unit;

FIG. 2 is an enlarged vertical sectional view of a magnetic recording disk according to a first embodiment of the present invention;

FIG. 3 is an enlarged vertical sectional view of the magnetic recording disk in detail;

FIG. 4 is an enlarged partial sectional view of a substrate for the magnetic recording disk for schematically illustrating the process of forming a magnetic underlayer on the surface of a substrate;

FIG. 5 is an enlarged partial sectional view of the substrate for schematically illustrating the process of forming a controlling layer on the surface of the magnetic underlayer;

FIG. 6 is an enlarged partial sectional view of the substrate for schematically illustrating the process of forming a first non-magnetic polycrystalline underlayer on the surface of the controlling layer;

FIG. 7 is an enlarged partial sectional view of the substrate for schematically illustrating the process of forming a second non-magnetic polycrystalline underlayer on the surface of the first non-magnetic polycrystalline underlayer;

FIG. 8 is an enlarged partial sectional view of the substrate for schematically illustrating the process of forming a first non-magnetic polycrystalline intermediate layer on the surface of the second non-magnetic polycrystalline underlayer;

FIG. 9 is an enlarged partial sectional view of the substrate for schematically illustrating the process of forming a second non-magnetic polycrystalline intermediate layer on the surface of the first non-magnetic polycrystalline intermediate layer;

FIG. 10 is an enlarged partial sectional view of the substrate for schematically illustrating the process of forming a first magnetic polycrystalline layer on the surface of the second non-magnetic polycrystalline intermediate layer;

FIG. 11 is an enlarged partial sectional view of the substrate for schematically illustrating the process of forming a second magnetic polycrystalline layer on the surface of the first magnetic polycrystalline layer;

FIG. 12 is an enlarged partial sectional view of the substrate for schematically illustrating the walls of a non-magnetic element extending along the grain boundaries; and

FIG. 13 is an enlarged vertical sectional view of a magnetic recording disk in detail according to a second embodiment of the present invention.

### DESCRIPTION OF THE PREFERRED EMBODIMENTS

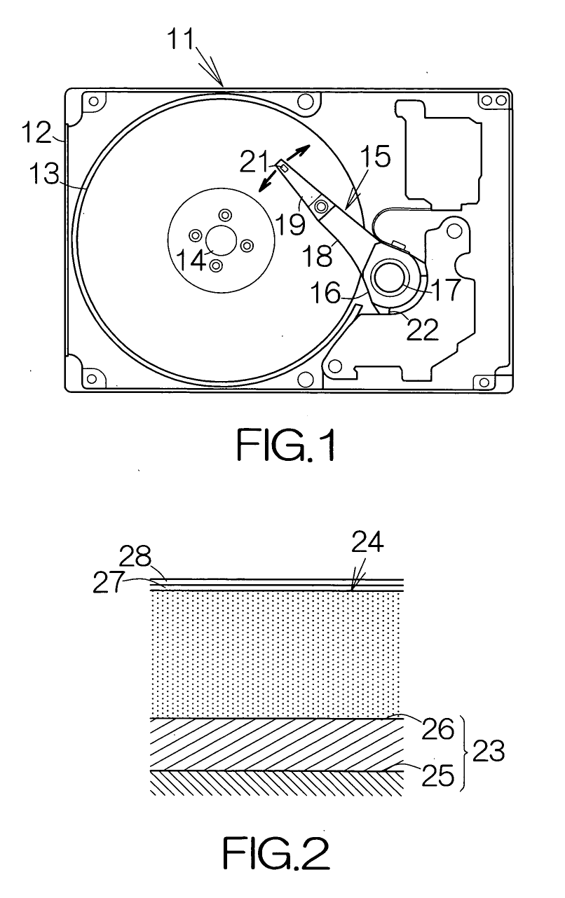

FIG. 1 schematically illustrates the inner structure of a hard disk drive, HDD, 11 as an example of a recording medium drive or storage device. The hard disk drive 11 includes a box-shaped enclosure 12 defining an inner space of a flat parallelepiped, for example. At least one magnetic recording disk 13 as a recording medium is incorporated within the inner space of the enclosure 12. The magnetic recording disk or disks 13 is mounted on the driving shaft of a spindle motor 14. The spindle motor 14 drives the magnetic recording disk or disks 13 at a higher revolution speed such as 7,200 rpm, 10,000 rpm, 15,000 rpm, or the like. A cover, not shown, is coupled to the enclosure 12. The cover closes the opening of the inner space within the enclosure 12.

A head actuator 15 is also incorporated within the inner space of the enclosure 12. The head actuator 15 includes an actuator block 16. The actuator block 16 is supported on a vertical support shaft 17 for relative rotation. Rigid actuator arms 18 are defined in the actuator block 16. The actuator arms 18 are designed to extend in a horizontal direction from the vertical support shaft 17. The actuator arms 18 are respectively related to the front and back surfaces of the magnetic recording disk 13. The actuator block 16 may be made of a metallic material such as aluminum, for example. Casting process may be employed to form the actuator block 16.

A head suspension 19 is fixed to the tip end of the individual actuator arm 18 so as to further extend forward from the actuator arm 18. A flying head slider 21 is supported on the tip or front end of the head suspension 19. The flying head slider 21 is designed to oppose its medium-opposed surface or bottom surface to the surface of the magnetic recording disk 13.

An electromagnetic transducer, not shown, is mounted on the flying head slider 21. The electromagnetic transducer may include a read element and a write element. The read element may include a giant magnetoresistive (GMR) element or a tunnel-junction magnetoresistive (TMR) element designed to discriminate magnetic information data on the magnetic recording disk 13 by utilizing variation in the electric resistance of a spin valve film or a tunnel-junction film, for example. The write element may include a thin film magnetic head designed to write magnetic information data into the magnetic recording disk 13 by utilizing magnetic field induced at a thin film coil pattern.

The head suspension 19 serves to urge the flying head slider 21 toward the surface of the magnetic recording disk 13. When the magnetic recording disk 13 rotates, the flying head slider 21 is allowed to receive airflow generated along the rotating magnetic recording disk 13. The airflow serves to generate positive pressure or a lift acting on the flying head slider 21. The flying head slider 21 is thus allowed to keep flying above the surface of the magnetic recording disk 13 during the rotation of the magnetic recording disk 13 at a higher stability established by the balance between the urging force of the head suspension 19 and the lift.

A power source or voice coil motor, VCM, 22 is coupled to the actuator block 16. The voice coil motor 22 serves to drive the actuator block 16 around the vertical support shaft 17. The rotation of the actuator block 16 realizes the swinging movement of the actuator arms 18 and the head suspensions 19. When the actuator arm 18 is driven to swing around the vertical support shaft 17 during the flight of the flying head slider 21, the flying head slider 21 is allowed to move along the radial direction of the magnetic recording disk 13. The electromagnetic transducer on the flying head slider 21 can thus be positioned right above a target recording track on the magnetic recording disk 13. As conventionally known, in the case where two or more of the magnetic recording disks 13 are incorporated in the inner space of the enclosure 12, a pair of the actuator arms 18 or head suspensions 19 is located in a space between the adjacent magnetic recording disks 13.

FIG. 2 illustrates in detail the structure of the magnetic recording disk 13 according to a first embodiment of the present invention. The magnetic recording disk 13 includes a substrate 23 as a support member, and multilayered structure films 24 respectively extending over the front and back surfaces of the substrate 23. The substrate 23 may comprise a disk-shaped Si body 25 and amorphous SiO₂ laminations 26 covering over the front and back surfaces of the Si body 25, for example. Alternatively, a glass or aluminum substrate may be employed in place of the substrate 23 of the aforementioned type. Magnetic information data is recorded in the multilayered structure films 24. The multilayered structure film 24 is covered with a protection overcoat 27 and a lubricating agent film 28. A carbon material such as diamond-like-carbon (DLC) may be utilized to form the protection overcoat 27. A perfluoropolyether (PFPE) film may be employed as the lubricating agent film 28, for example.

As shown in FIG. 3, the multilayered structure film 24 includes a magnetic underlayer 31 extending over the surface of the substrate 23. The magnetic underlayer 31 may be made of a soft magnetic material such as FeTaC, NiFe, or the like. Here, a FeTaC film having the thickness of 300 nm approximately is employed as the magnetic underlayer 31. The axis of easy magnetization is aligned in a direction parallel to the surface of the substrate 23 in the magnetic underlayer 31.

A controlling layer 32 extends over the surface of the magnetic underlayer 31. The controlling layer 32 includes crystal grains oriented in a predetermined direction. A non-magnetic layer such as a MgO layer may be employed as the controlling layer 32, for example. Here, a MgO layer having thickness in a range between 10.0 nm and 20.0 nm approximately is employed as the controlling layer 32. The (100) plane is preferentially oriented in a predetermined direction in the individual crystal grains of the MgO layer.

A first non-magnetic polycrystalline underlayer 33 extends over the surface of the controlling layer 32. The first non-magnetic polycrystalline underlayer 33 includes crystal grains arranged adjacent to each other on the substrate 23. Here, a Ti layer having a thickness equal to or smaller than 1.0 nm is employed as the first non-magnetic polycrystalline underlayer 33, for example.

A second non-magnetic polycrystalline underlayer 34 extends over the surface of the first non-magnetic polycrystalline underlayer 33. The second non-magnetic polycrystalline underlayer 34 is designed to have a thickness larger than that of the first non-magnetic polycrystalline underlayer 33. The second non-magnetic polycrystalline underlayer 34 may include crystal grains each having grown from the corresponding one of the crystal grains of the first non-magnetic polycrystalline underlayer 33 based on the epitaxy. The second non-magnetic polycrystalline underlayer 34 may contain at least one element contained in the first non-magnetic polycrystalline underlayer 33. Here, a Ti layer having a thickness in a range between 2.0 nm and 5.0 nm approximately is employed as the second non-magnetic polycrystalline underlayer 34, for example.

A first non-magnetic polycrystalline intermediate layer 35 extends over the surface of the second non-magnetic polycrystalline underlayer 34. The first non-magnetic polycrystalline intermediate layer 35 includes crystal grains arranged adjacent to each other on the surface of the second non-magnetic polycrystalline underlayer 34. The first non-magnetic polycrystalline intermediate layer 35 may be made of an alloy containing Co and Cr, for example. Here, a CoCr layer having a thickness equal to or smaller than 1.0 nm is employed as the first non-magnetic polycrystalline intermediate layer 35.

A second non-magnetic polycrystalline intermediate layer 36 extends over the surface of the first non-magnetic polycrystalline intermediate layer 35. The second non-magnetic polycrystalline intermediate layer 36 is designed to have a thickness larger than that of the first non-magnetic polycrystalline intermediate layer 35. The second non-magnetic polycrystalline intermediate layer 36 includes crystal grains each having grown from the corresponding one of the crystal grains of the first non-magnetic polycrystalline intermediate layer 35 based on the epitaxy. The second non-magnetic polycrystalline intermediate layer 36 may be made of an alloy containing Co and Cr, for example. The second non-magnetic polycrystalline intermediate layer 36 may contain at least one element contained in the first non-magnetic polycrystalline intermediate layer 35. Here, a CoCr layer having the thickness of 2.0 nm approximately is employed as the second non-magnetic polycrystalline intermediate layer 36.

A first magnetic polycrystalline layer 37 extends over the surface of the second non-magnetic polycrystalline intermediate layer 36. The first magnetic polycrystalline layer 37 includes crystal grains arranged adjacent to each other on the surface of the second non-magnetic polycrystalline intermediate layer 36. The first magnetic polycrystalline layer 37 may contain at least one non-magnetic element contained in the second non-magnetic polycrystalline intermediate layer 36. The first magnetic polycrystalline layer 37 may be made of an alloy containing Co and Cr, for example. Here, a CoCrPt layer having a thickness equal to or smaller than 1.0 nm is employed as the first magnetic polycrystalline layer 37, for example. The (001) plane is preferentially oriented in a predetermined direction in the individual crystal grains of the first magnetic polycrystalline layer 37.

A second magnetic polycrystalline layer 38 extends over the surface of the first magnetic polycrystalline layer 37. The second magnetic polycrystalline layer 38 is designed to have a thickness larger than that of the first magnetic polycrystalline layer 37. The second magnetic polycrystalline layer 38 includes crystal grains each having grown from the corresponding one of the crystal grains of the first magnetic polycrystalline layer 37 based on the epitaxy. The second magnetic polycrystalline layer 38 may contain at least one element contained in the first magnetic polycrystalline layer 37. Here, a CoCrPt layer having the thickness of 20.0 nm approximately is employed as the second magnetic polycrystalline layer 38, for example. The epitaxy serves to establish grain boundaries 39 between the adjacent magnetic crystal grains. Atoms belonging to a non-magnetic element such as Cr segregate along the grain boundaries 39. This segregation serves to establish the walls of a non-magnetic element such as Cr between the adjacent magnetic crystal grains. The (001) plane is preferentially oriented in a predetermined direction in the individual crystal grains of the second magnetic polycrystalline layer 38. The axis of easy magnetization is thus established in the vertical direction perpendicular to the surface of the substrate 23. Magnetic information data is recorded in the first and second magnetic polycrystalline layers 37, 38.

Fine and uniform crystal grains are established in the first and second magnetic polycrystalline layers 37, 38. Since the walls of the non-magnetic element are formed along the individual grain boundaries 39 in the aforementioned manner, magnetic interaction can reliably be suppressed between the adjacent magnetic crystal grains. The suppression of the magnetic interaction serves to greatly reduce the transition noise between the adjacent recording tracks on the surface of the magnetic recording disk 13. Moreover, the first and second magnetic polycrystalline layers 37, 38 are allowed to obtain a sufficient thickness regardless of the establishment of the fine crystal grains. The axis of easy magnetization is reliably aligned in the vertical direction perpendicular to the surface of the substrate 23 with a higher accuracy. A higher signal-to-noise (S/N) ratio can be obtained in reading magnetic information data.

Next, a detailed description will be made on a method of making the magnetic recording disk 13. First of all, the disk-shaped substrate 23 is prepared. The substrate 23 is set in a sputtering apparatus. A vacuum condition is established in a chamber of the sputtering apparatus. The multilayered structure film 24 is formed on the surface of the substrate 23 in the chamber of the sputtering apparatus. The processes will be described later in detail. The protection overcoat 27 is then formed on the surface of the multilayered structure film 24. Chemical vapor deposition, CVD, may be employed to form the protection overcoat 27. The lubricating agent film 28 is subsequently applied to the surface of the protection overcoat 27. The substrate 23 may be dipped into a solution containing perfluoropolyether, for example.

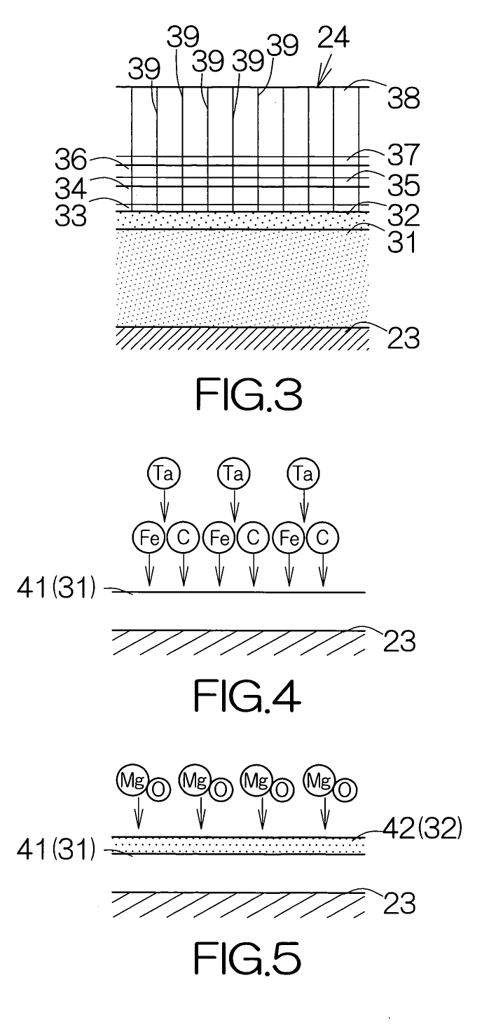

A FeTaC target is first set in the sputtering apparatus to form the multilayered structure film 24. As shown in FIG. 4, Fe atoms, Ta atoms and C atoms are sputtered out of the FeTaC target in the chamber in the vacuum condition. Specifically, a so-called radio or high frequency sputtering is effected in the sputtering apparatus. The Fe atoms, Ta atoms and C atoms are allowed to deposit on the surface of the substrate 23. The normal or room temperature is kept during the deposition of the atoms in the chamber in this case. The magnetic underlayer 31, namely a FeTaC layer 41 having the thickness of 300nm approximately, is in this manner formed on the surface of the substrate 23.

As shown in FIG. 5, MgO is then deposited on the surface of the FeTaC layer 41 in the vacuum condition in the sputtering apparatus. The room temperature is kept in the chamber of the sputtering apparatus. The controlling layer 32, namely a MgO layer 42 having the thickness of 16.7 nm approximately, is in this manner formed on the surface of the FeTaC layer 41. Since the room temperature is kept in the chamber during the deposition of the MgO, the (100) plane is preferentially oriented in a predetermined direction in the individual non-magnetic crystal grains of the MgO layer 42.

A Ti target is then set in the sputtering apparatus. As shown in FIG. 6, Ti atoms are sputtered out of the Ti target in the chamber of the sputtering apparatus in the vacuum condition. The Ti atoms are allowed to deposit on the surface of the MgO layer 42. The temperature of the substrate 23 is kept at the room temperature during the deposition of the Ti atoms. Migration of the Ti atoms can be prevented on the surface of the substrate 23, if the temperature of the substrate 23 is in this manner kept equal to or below 200 degrees Celsius. A Ti layer 43 having the thickness of 0.4 nm approximately is formed on the surface of the MgO layer 42. Here, crystal grains cannot sufficiently be established in the Ti layer 43.

The Ti layer 43 is subsequently subjected to heat treatment. Heat of 350 degrees Celsius is applied to the Ti layer 43 in the vacuum condition. The application of heat continues for one minute. The substrate 23 may be set on a heating block, for example. The applied heat promotes the crystallization of the Ti layer 43. The MgO layer 42 serves to align the orientation of the crystal grains in a predetermined direction in the Ti layer 43. Fine and uniform crystal grains are established in the Ti layer 43. The first non-magnetic polycrystalline underlayer 33 is in this manner formed on the MgO layer 42.

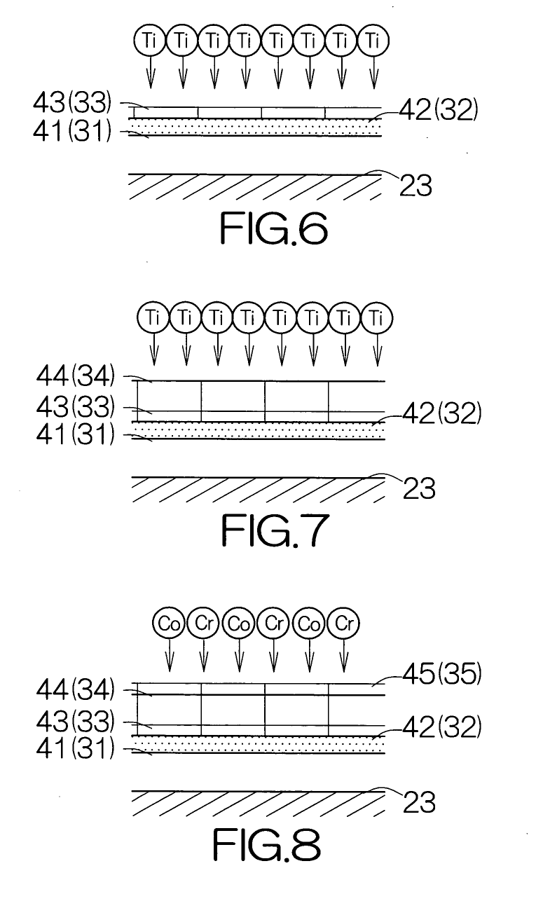

As shown in FIG. 7, Ti atoms are then sputtered out of the Ti target in the chamber in the vacuum condition. The Ti atoms are allowed to deposit on the surface of the Ti layer 43 in the aforementioned manner. The room temperature is still kept in the chamber of the sputtering apparatus. Fine and uniform crystal grains respectively grow from the corresponding crystal grains of the Ti layer 43 based on the epitaxy. A Ti layer 44 having the thickness of 3.6 nm approximately is formed on the surface of the Ti layer 43. The second non-magnetic polycrystalline underlayer 34 is in this manner formed to have a thickness larger than that of the first non-magnetic polycrystalline underlayer 33.

A CoCr target is then set in the sputtering apparatus. As shown in FIG. 8, a first group of atoms, namely Co atoms and Cr atoms, are sputtered out of the CoCr target in the chamber of the sputtering apparatus in the vacuum condition. The Co and Cr atoms are allowed to deposit on the surface of the Ti layer 44. The temperature of the substrate 23 is kept at the room temperature during the deposition of the Co and Cr atoms in the same manner as described above. Migration of the Co and Cr atoms can be prevented on the surface of the substrate 23, if the temperature of the substrate 23 is in this manner kept equal to or below 200 degrees Celsius during the deposition of the Co and Cr atoms. A CoCr layer 45 having the thickness of 0.5 nm approximately is in this manner formed on the surface of the Ti layer 44. Here, crystal grains cannot sufficiently be established in the CoCr layer 45.

The CoCr layer 45 is subsequently subjected to heat treatment. Heat of 350 degrees Celsius is applied to the CoCr layer 45 in the vacuum condition. The application of heat continues for one minute. The substrate 23 may be set on a heating block, for example. The applied heat promotes the crystallization of the CoCr layer 45. Fine and uniform crystal grains are established in the CoCr layer 45. The first non-magnetic polycrystalline intermediate layer 35 is in this manner formed on the Ti layer 44.

A second group of atoms, namely Co atoms and Cr atoms, are then sputtered out of the CoCr target in the chamber of the sputtering apparatus in the vacuum condition, as shown in FIG. 9. The Co and Cr atoms are allowed to deposit on the surface of the CoCr layer 45 in the same manner as described above. The temperature of the substrate 23 is kept at the room temperature during the deposition of the Co and Cr atoms. Fine and uniform crystal grains respectively grow from the corresponding crystal grains of the CoCr layer 45 based on the epitaxy. A CoCr layer 46 having the thickness of 2.0 nm approximately is thus formed on the surface of the CoCr layer 45. The second non-magnetic polycrystalline intermediate layer 36 is in this manner formed to have a thickness larger than that of the first non-magnetic polycrystalline intermediate layer 35. In this case, the second group of atoms may include atoms belonging to at least one element contained in the first non-magnetic polycrystalline intermediate layer 35.

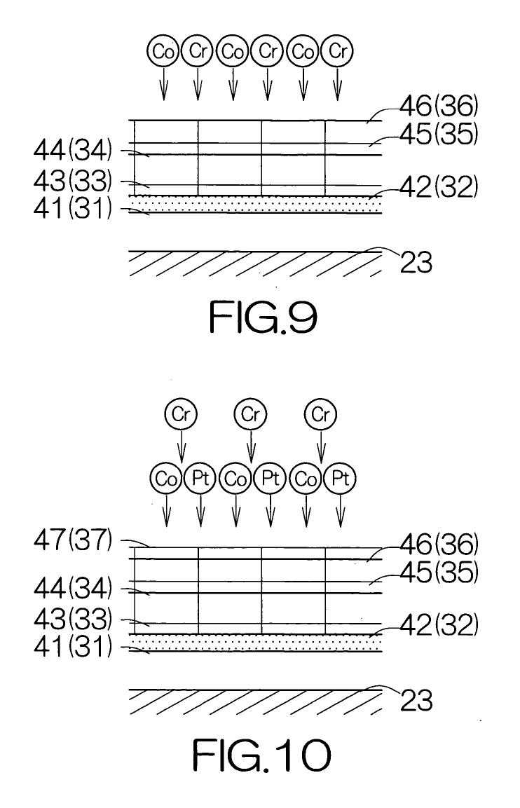

A CoCrPt target is then set in the sputtering apparatus. As shown in FIG. 10, a third group of atoms, namely Co atoms, Cr atoms and Pt atoms, are sputtered out of the CoCrPt target in the chamber of the sputtering apparatus in the vacuum condition. The Co, Cr and Pt atoms are allowed to deposit on the surface of the CoCr layer 46. The temperature of the substrate 23 is kept at the room temperature during the deposition of the Co, Cr and Pt atoms. Migration of the Co, Cr and Pt atoms can be prevented on the surface of the substrate 23, if the temperature of the substrate 23 is in this manner kept equal to or below 200 degrees Celsius. A CoCrPt layer 47 having the thickness of 0.5 nm approximately is thus formed on the surface of the CoCr layer 46. Here, crystal grains cannot sufficiently be established in the CoCrPt layer 47. In this case, the third group of atoms may include atoms belonging to at least one non-magnetic element contained in the second non-magnetic polycrystalline intermediate layer 36.

The CoCrPt layer 47 is subsequently subjected to heat treatment. Heat of 350 degrees Celsius is applied to the CoCrPt layer 47 in the vacuum condition. The application of heat continues for one minute. The substrate 23 may be set on a heating block, for example. The applied heat promotes the crystallization of the CoCrPt layer 47. Fine and uniform crystal grains are established in the CoCrPt layer 47. The first magnetic polycrystalline layer 37 is in this manner formed on the CoCr layer 46.

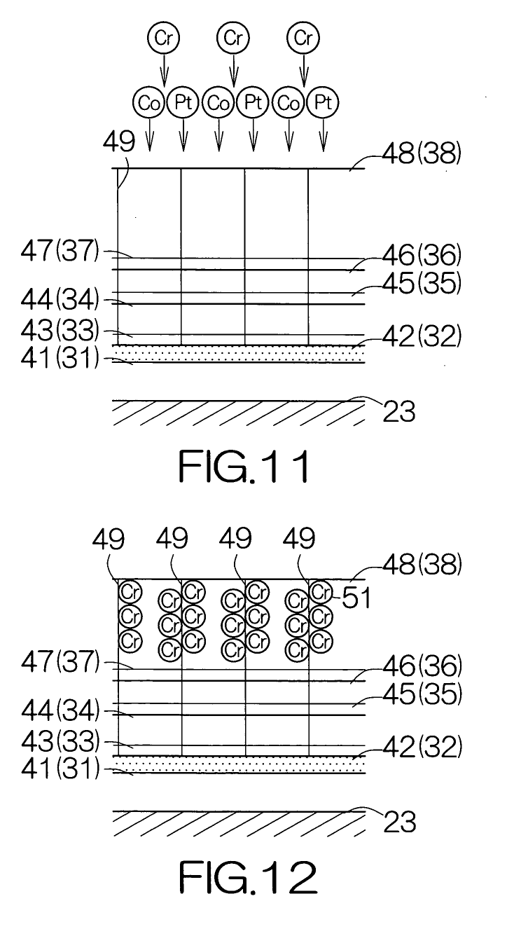

A fourth group of atoms, namely Co atoms, Cr atoms and Pt atoms, are then sputtered out of the CoCrPt target in the chamber of the sputtering apparatus in the vacuum condition, as shown in FIG. 11. The Co, Cr and Pt atoms are allowed to deposit on the surface of the CoCrPt layer 47 in the same manner as described above. The temperature of the substrate 23 is kept at the room temperature during the deposition of the Co, Cr and Pt atoms. Fine and uniform crystal grains respectively grow from the corresponding crystal grains of the CoCrPt layer 47 based on the epitaxy. A CoCrPt layer 48 having the thickness of 20.0 nm approximately is formed on the surface of the CoCrPt layer 47. The grain boundaries 49 are established in the CoCrPt layer 48. The fourth group of atoms may include atoms belonging to at least one non-magnetic element contained in the second non-magnetic polycrystalline intermediate layer 36.

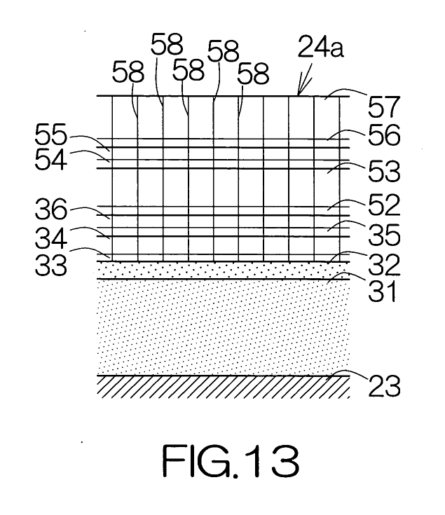

The substrate 23 is subsequently subjected to heat treatment. Heat of 350 degrees Celsius is applied at least to the CoCr layer 46, the CoCrPt layer 47 and the CoCrPt layer 48 in the vacuum condition. The application of heat continues for one minute. The substrate 23 may be placed on a heating block, for example. As shown in FIG. 12, Cr atoms 51 move out of the CoCr layer 46 into the CoCrPt layers 47, 48 along the grain boundaries 49 in response to the application of heat. This segregation serves to establish the wall of a non-magnetic element along the grain boundaries 49 in the CoCrPt layer 48. The second magnetic polycrystalline layer 38 is in this manner formed to have a thickness larger than that of the first magnetic polycrystalline layer 37.

A vacuum condition is kept during a period from the deposition of the first group of atoms until the completion of the heat treatment after the deposition of the fourth group of atoms, namely during a period from the establishment of the Ti layer 43 until the completion of the heat treatment to the CoCr layer 46, the CoCrPt layer 47 and the CoCrPt layer 48, in the aforementioned sputtering process.

The method of making the magnetic recoding disk 13 enables a reliable prevention of migration of Ti atoms during the deposition for the establishment of the Ti layer 43. The Ti layer 43 is allowed to have a thickness significantly smaller than the overall thickness of the non-magnetic polycrystalline underlayers 33, 34, so that fine and uniform crystal grains can be established in the Ti layer 43 during the crystallization. The deposition of the Ti atoms is thereafter continued until the establishment of a sufficient thickness. Migration can still be suppressed during the continued deposition. Accordingly, fine and uniform crystal grains can also be established in the Ti layer 44. Enlargement of the crystal grains is thus reliably prevented in the first and second non-magnetic polycrystalline underlayers 33, 34.

The method also enables a reliable prevention of migration of Co atoms and Cr atoms during the deposition for the establishment of the CoCr layer 45. The CoCr layer 45 is allowed to have a thickness significantly smaller than the overall thickness of the non-magnetic polycrystalline intermediate layers 35, 36, so that fine and uniform crystal grains can be established in the CoCr layer 45 during the crystallization. The deposition of the Co and Cr atoms is thereafter continued until the establishment of a sufficient thickness. Migration can still be suppressed during the continued deposition. Accordingly, fine and uniform crystal grains can also be established in the CoCr layer 46. Enlargement of the crystal grains is thus reliably prevented in the first and second non-magnetic polycrystalline intermediate layers 35, 36.

The method also enables a reliable prevention of migration of Co atoms, Cr atoms and Pt atoms during the deposition for the establishment of the CoCrPt layer 47. The CoCrPt layer 47 is allowed to have a thickness significantly smaller than the overall thickness of the magnetic polycrystalline layers 37, 38, so that fine and uniform crystal grains can be established in the CoCrPt layer 47 during the crystallization. The deposition of the Co, Cr and Pt atoms is thereafter continued until the establishment of a sufficient thickness. Migration can still be suppressed during the continued deposition. Accordingly, fine and uniform crystal grains can also be established in the CoCrPt layer 48. Enlargement of the crystal grains is thus reliably prevented in the first and second magnetic polycrystalline layers 37, 38. In addition, the Ti layers 43, 44 serve to reliably establish the orientation of the crystal grains aligned in a predetermined direction in the CoCrPt layers 47, 48.

The Cr atoms 51 move out of the CoCr layer 46 into the CoCrPt layers 47, 48 along the grain boundaries 49 in response to the application of heat at least to the CoCr layer 46, the CoCrPt layer 47 and the CoCrPt layer 48. This results in the establishment of the walls of a non-magnetic element along the grain boundaries 49 in the CoCrPt layer 48. The wall serves to reliably suppress magnetic interaction between the adjacent magnetic crystal grains. A higher S/N ratio can be obtained in reading magnetic information data.

FIG. 13 illustrates in detail the structure of a magnetic recording disk 13a according to a second embodiment of the present invention. The magnetic recording disk 13a includes a multilayered structure film 24a. The multilayered structure film 24a includes a first magnetic polycrystalline layer 52 extending over the surface of the second non-magnetic polycrystalline intermediate layer 36. A second magnetic polycrystalline layer 53 extends over the surface of the first magnetic polycrystalline layer 52. A first non-magnetic polycrystalline layer 54 extends over the surface of the second magnetic polycrystalline layer 53. A second non-magnetic polycrystalline layer 55 extends over the surface of the first non-magnetic polycrystalline layer 54. A third magnetic polycrystalline layer 56 extends over the surface of the second non-magnetic polycrystalline layer 55. A fourth magnetic polycrystalline layer 57 extends over the surface of the third magnetic polycrystalline layer 56. Like reference numerals are attached to the structure or components equivalent to those of the aforementioned first embodiment.

The first magnetic polycrystalline layer 52 includes crystal grains arranged adjacent to each other on the surface of the second non-magnetic polycrystalline intermediate layer 36. The second magnetic polycrystalline layer 53 includes crystal grains arranged adjacent to each other on the surface of the first magnetic polycrystalline layer 52. The second magnetic polycrystalline layer 53 is designed to have a thickness larger than that of the first magnetic polycrystalline layer 52. The second magnetic polycrystalline layer 53 may contain at least one element contained in the first magnetic polycrystalline layer 52. The first and second magnetic polycrystalline layers 52, 53 may respectively contain at least one non-magnetic element contained in the second non-magnetic polycrystalline intermediate layer 36. The second magnetic polycrystalline layer 53 includes crystal grains each having grown from the corresponding one of the crystal grains of the first magnetic polycrystalline layer 52 based on the epitaxy. Here, a CoCrPt layer having a thickness equal to or smaller than 1.0 nm is employed as the first magnetic polycrystalline layer 52. A CoCrPt layer having the thickness of 10.0 nm approximately is employed as the second magnetic polycrystalline layer 53. The first and second magnetic polycrystalline layers 52, 53 in combination serve as a lower magnetic polycrystalline layer according to the present invention.

The first non-magnetic polycrystalline layer 54 includes crystal grains arranged adjacent to each other on the surface of the second magnetic polycrystalline layer 53. The first non-magnetic polycrystalline layer 54 may be made of an alloy containing Co and Cr, for example. Here, a CoCr layer having a thickness equal to or smaller than 1.0 nm is employed as the first non-magnetic polycrystalline layer 54. The second non-magnetic polycrystalline layer 55 is designed to have a thickness larger than that of the first non-magnetic polycrystalline layer 54. The second non-magnetic polycrystalline layer 55 may contain at least one element contained in the first non-magnetic polycrystalline layer 54. The second non-magnetic polycrystalline layer 55 includes crystal grains each having grown from the corresponding one of the crystal grains of the first non-magnetic polycrystalline layer 54 based on the epitaxy. The second non-magnetic polycrystalline layer 55 may be made of an alloy containing Co and Cr, for example. Here, a CoCr layer having the thickness of 2.0 nm approximately is employed as the second non-magnetic polycrystalline layer 55.

The third magnetic polycrystalline layer 56 includes crystal grains arranged adjacent to each other on the surface of the second non-magnetic polycrystalline layer 55. The fourth magnetic polycrystalline layer 57 is designed to have a thickness larger than that of the third magnetic polycrystalline layer 56. The fourth magnetic polycrystalline layer 57 may contain at least one element contained in the third magnetic polycrystalline layer 56. The third and fourth magnetic polycrystalline layers 56, 57 may respectively contain at least one non-magnetic element contained in the second non-magnetic polycrystalline layer 55. The fourth magnetic polycrystalline layer 57 includes crystal grains each having grown from the corresponding one of the crystal grains of the third magnetic polycrystalline layer 56 based on the epitaxy. Here, a CoCrPt layer having a thickness equal to or smaller than 1.0 nm is employed as the third magnetic polycrystalline layer 56. A CoCrPt layer having the thickness of 10.0 nm approximately is employed as the fourth magnetic polycrystalline layer 57. The third and fourth magnetic polycrystalline layers 56, 57 in combination serve as an upper magnetic polycrystalline layer according to the present invention. Magnetic information data is recorded in the upper and lower magnetic polycrystalline layers 52, 53, 56, 57.

The magnetic recording disk 13a enables the establishment of fine and uniform crystal grains in the upper and lower magnetic polycrystalline layers 52, 53, 56, 57. Since the walls of a non-magnetic element is formed along individual grain boundaries 58 in the upper and lower magnetic polycrystalline layers 52, 53, 56, 57, magnetic interaction can reliably be suppressed between the adjacent magnetic crystal grains. The suppression of the magnetic interaction serves to greatly reduce the transition noise between the adjacent recording tracks on the surface of the magnetic recording disk 13a. Moreover, the upper and lower magnetic polycrystalline layers 52, 53, 56, 57 are allowed to obtain a sufficient thickness regardless of the establishment of the fine crystal grains. The axes of easy magnetization are reliably aligned in the vertical direction perpendicular to the surface of the substrate 23 with a higher accuracy. In particular, the magnetic recording disk 13a enables enhancement of the coercivity in the upper and lower magnetic polycrystalline layers 52, 53, 56, 57 as compared with the aforementioned magnetic recording disk 13. A higher S/N ratio can be obtained in reading magnetic information data.

Next, a brief description will be made on the method of making the magnetic recording disk 13a. First of all, the disk-shaped substrate 23 is prepared. The magnetic underlayer 31, the controlling layer 32, the first and second non-magnetic polycrystalline underlayers 33, 34, and the first and second non-magnetic polycrystalline intermediate layers 35, 36 may be formed on the substrate 23 in the aforementioned manner. Sputtering may be employed in this case, for example.

A third group of atoms, namely Co atoms, Cr atoms and Pt atoms, are then sputtered out of the CoCrPt target in the chamber of the sputtering apparatus in the vacuum condition. The Co, Cr and Pt atoms are allowed to deposit on the surface of the second non-magnetic polycrystalline intermediate layer 36. A CoCrPt layer having the thickness of 0.5 nm approximately is in this manner formed on the surface of the second non-magnetic polycrystalline intermediate layer 36. The CoCrPt layer is subsequently subjected to heat treatment. The applied heat promotes the crystallization of the CoCrPt layer. This results in the establishment of the first magnetic polycrystalline layer 52 on the second non-magnetic polycrystalline intermediate layer 36. Co atoms, Cr atoms and Pt atoms are then deposited on the surface of the CoCrPt layer in the vacuum condition. A CoCrPt layer having the thickness of 10.0 nm approximately is formed on the surface of the CoCrPt layer in the same manner as described above. This results in the establishment of the second magnetic polycrystalline layer 53 on the surface of the first magnetic polycrystalline layer 52. The third group of atoms may include atoms belonging to at least one non-magnetic element contained in the second non-magnetic polycrystalline intermediate layer 36.

A fourth group of atoms, namely Co atoms and Cr atoms, are then sputtered out of the CoCr target in the chamber of the sputtering apparatus in the vacuum condition. The Co and Cr atoms are allowed to deposit on the surface of the second magnetic polycrystalline layer 53. A CoCr layer having the thickness of 0.5 nm approximately is in this manner formed on the surface of the second magnetic polycrystalline layer 53. The CoCr layer is subsequently subjected to heat treatment. The applied heat promotes the crystallization of the CoCr layer. The Cr atoms move out of the second non-magnetic polycrystalline intermediate layer 36 into the first and second magnetic polycrystalline layers 52, 53 along the grain boundaries 58 in response to the application of heat to the second non-magnetic polycrystalline intermediate layer 36 and the first and second magnetic polycrystalline layers 52, 53. This segregation serves to establish the walls of a non-magnetic element along the grain boundaries 58 in the first and second magnetic polycrystalline layers 52, 53. The first non-magnetic polycrystalline layer 54 is in this manner formed on the surface of the second magnetic polycrystalline layer 53. A fifth group of atoms, namely Co atoms and Cr atoms, are then sputtered out of the CoCr target in the chamber of the sputtering apparatus in the vacuum condition A CoCr layer having the thickness of 2.0 nm approximately is formed on the surface of the first non-magnetic polycrystalline layer 54. This results in the establishment of the second non-magnetic polycrystalline layer 55. The fifth group of atoms may include atoms belonging to at least one element contained in the first non-magnetic polycrystalline layer 54.

A sixth group of atoms, namely Co atoms, Cr atoms and Pt atoms, are then sputtered out of the CoCrPt target in the chamber of the sputtering apparatus in the vacuum condition. The Co, Cr and Pt atoms are allowed to deposit on the surface of the second non-magnetic polycrystalline layer 55. A CoCrPt layer having the thickness of 0.5 nm approximately is formed on the surface of the second non-magnetic polycrystalline layer 55. The CoCrPt layer is subsequently subjected to heat treatment. The applied heat promotes the crystallization of the CoCrPt layer. This results in the establishment of the third magnetic polycrystalline layer 56 on the surface of the second non-magnetic polycrystalline layer 55. Co atoms, Cr atoms and Pt atoms are then sputtered out of the CoCrPt target in the chamber of the sputtering apparatus in the vacuum condition. The Co, Cr and Pt atoms are allowed to deposit on the surface of the CoCrPt layer. A CoCrPt layer having the thickness of 10.0 nm approximately is formed on the surface of the CoCrPt layer. This results in the establishment of the fourth magnetic polycrystalline layer 57 on the surface of the third magnetic polycrystalline layer 56. The sixth group of atoms may include atoms belonging to at least one non-magnetic element contained in the second non-magnetic polycrystalline intermediate layer 36.

The second non-magnetic polycrystalline layer 55 and the third and fourth magnetic polycrystalline layers 56, 57 are subsequently subjected to heat treatment. Cr atoms move out of the second non-magnetic polycrystalline layer 55 into the third and fourth magnetic polycrystalline layers 56, 57 along the grain boundaries 58 in response to the application of heat to the second non-magnetic polycrystalline layer 55 and the third and fourth magnetic polycrystalline layers 56, 57. This segregation serves to establish the walls of a non-magnetic element along the grain boundaries 58 in the third and fourth magnetic polycrystalline layers 56, 57. This results in the establishment of the fourth magnetic polycrystalline layer 57 having a thickness larger than that of the third magnetic polycrystalline layer 56.

A vacuum condition is kept during a period from the deposition of the first group of atoms until the completion of the heat treatment after the deposition of the sixth group of atoms, namely during a period from the establishment of the first non-magnetic polycrystalline intermediate layer 35 until the completion of the heat treatment to the second non-magnetic polycrystalline layer 55 and the third and fourth magnetic polycrystalline layers 56, 57 in the aforementioned sputtering process.

The aforementioned first and second magnetic polycrystalline layers 37, 38, 52, 53 and the third and fourth magnetic polycrystalline layers 56, 57 may respectively allow establishment of the axis of easy magnetization aligned in the directions parallel to the surface of the substrate 23. In this case, the aforementioned method of the first embodiment may be employed to form the first and second magnetic polycrystalline layers 37, 38, the first and second non-magnetic polycrystalline intermediate layers 35, 36, and the first and second non-magnetic polycrystalline underlayers 33, 34. The aforementioned method of the second embodiment may be employed to form the first to fourth magnetic polycrystalline layers 52, 53, 56, 57 and the first and second non-magnetic polycrystalline layers 54, 55.

The aforementioned magnetic recording disk 13, 13a may include a separating layer such as a SiO₂ layer between the magnetic underlayer 31 or FeTaC layer 41 and the first non-magnetic polycrystalline underlayer 33 or Ti layer 43 in place of the controlling layer 32 or MgO layer 42. The separating layer serves to suppress the influence of the magnetic underlayer 31 on the first non-magnetic polycrystalline underlayer 33. This results in a reliable establishment of the orientation of the crystal grains aligned in a predetermined direction in the first non-magnetic polycrystalline underlayer 33 without suffering from the influence of the magnetic underlayer 31. Alternatively, the first and second non-magnetic polycrystalline underlayers 33, 34 may be made of Ru in the aforementioned magnetic recording disk 13, 13a.

What is claimed is:

1. A multilayered structure film comprising:
a non-magnetic polycrystalline underlayer;
a first non-magnetic polycrystalline intermediate layer including crystal grains adjacent to each other on a surface of the non-magnetic polycrystalline underlayer;
a second non-magnetic polycrystalline intermediate layer containing at least one element contained in the first non-magnetic polycrystalline intermediate layer, said second non-magnetic polycrystalline intermediate layer extending over a surface of the first non-magnetic polycrystalline intermediate layer by a thickness larger than thickness of the first non-magnetic polycrystalline intermediate layer, the second non-magnetic polycrystalline intermediate layer including crystal grains individually having grown from the crystal grains of the first non-magnetic polycrystalline intermediate layer; and
a magnetic polycrystalline layer including crystal grains adjacent to each other on a surface of the second non-magnetic polycrystalline intermediate layer, said magnetic polycrystalline layer containing at least one non-magnetic element contained in the second non-magnetic polycrystalline intermediate layer.

2. The multilayered structure film according to claim 1, wherein the magnetic polycrystalline layer comprises:
a first magnetic polycrystalline layer including crystal grains adjacent to each other on the surface of the second non-magnetic polycrystalline intermediate layer; and
a second magnetic polycrystalline layer containing at least one element contained in the first magnetic polycrystalline layer, said second magnetic polycrystalline layer extending over a surface of the first magnetic polycrystalline layer by a thickness larger than thickness of the first magnetic polycrystalline layer, said second magnetic polycrystalline layer including crystal grains individually having grown from the crystal grains of the first magnetic polycrystalline layer.

3. The multilayered structure film according to claim 2, wherein the first and second non-magnetic polycrystalline intermediate layers and the first and second magnetic polycrystalline layers are made of an alloy containing Co and Cr.

4. The multilayered structure film according to claim 1, wherein the non-magnetic polycrystalline underlayer comprises:
a first non-magnetic polycrystalline underlayer including crystal grains adjacent to each other; and
a second non-magnetic polycrystalline underlayer containing at least one element contained in the first non-magnetic polycrystalline underlayer, said second non-magnetic polycrystalline underlayer extending over a surface of the first non-magnetic polycrystalline underlayer by a thickness larger than thickness of the first non-magnetic polycrystalline underlayer, said second non-magnetic polycrystalline underlayer including crystal grains individually having grown from the crystal grains of the first non-magnetic polycrystalline underlayer.

5. The multilayered structure film according to claim 4, wherein the first and second non-magnetic polycrystalline underlayers are made of Ti.

6. A multilayered structure film comprising:
a non-magnetic polycrystalline underlayer;
a first non-magnetic polycrystalline intermediate layer including crystal grains adjacent to each other on a surface of the non-magnetic polycrystalline underlayer;
a second non-magnetic polycrystalline intermediate layer containing at least one element contained in the first non-magnetic polycrystalline intermediate layer, said second non-magnetic polycrystalline intermediate layer extending over a surface of the first non-magnetic polycrystalline intermediate layer by a thickness larger than thickness of the first non-magnetic polycrystalline intermediate layer, the second non-magnetic polycrystalline intermediate layer including crystal grains individually having grown from the crystal grains of the first non-magnetic polycrystalline intermediate layer;
a lower magnetic polycrystalline layer including crystal grains adjacent to each other on a surface of the second non-magnetic polycrystalline intermediate layer, said lower magnetic polycrystalline layer containing at least one non-magnetic element contained in the second non-magnetic polycrystalline intermediate layer;
a first non-magnetic polycrystalline layer including crystal grains adjacent to each other on a surface of the lower magnetic polycrystalline layer;
a second non-magnetic polycrystalline layer containing at least one element contained in the first non-magnetic polycrystalline layer, said second non-magnetic polycrystalline layer extending over a surface of the first non-magnetic polycrystalline layer by a thickness larger than thickness of the first non-magnetic polycrystalline layer, the second non-magnetic polycrystalline layer including crystal grains individually having grown from the crystal grains of the first non-magnetic polycrystalline layer; and
an upper magnetic polycrystalline layer including crystal grains adjacent to each other on a surface of the second non-magnetic polycrystalline layer, said upper magnetic polycrystalline layer containing at least one non-magnetic element contained in the second non-magnetic polycrystalline layer.

7. The multilayered structure film according to claim 6, wherein the lower and upper magnetic polycrystalline layers respectively comprise:
a first magnetic polycrystalline layer including crystal grains adjacent to each other; and
a second magnetic polycrystalline layer containing at least one element contained in the first magnetic polycrystalline layer, said second magnetic polycrystalline layer extending over a surface of the first magnetic polycrystalline layer by a thickness larger than thickness of the first magnetic polycrystalline layer, said second magnetic polycrystalline layer including crystal grains individually having grown from the crystal grains of the first magnetic polycrystalline layer.

8. The multilayered structure film according to claim 7, wherein the first and second non-magnetic polycrystalline intermediate layers, the first and second magnetic polycrystalline layers and the first and second non-magnetic polycrystalline layers are made of an alloy containing Co and Cr.

9. A method of making a multilayered structure film, comprising:
depositing a first group of atoms on a surface of an object;
subjecting the first group of atoms to heat treatment so as to form a first non-magnetic polycrystalline layer;
depositing a second group of atoms on a surface of the first non-magnetic polycrystalline layer so as to form a second non-magnetic polycrystalline layer having a thickness larger than thickness of the first non-magnetic polycrystalline layer, said second group of atoms including atoms of at least one element contained in the first non-magnetic polycrystalline layer;
depositing a third group of atoms on a surface of the second non-magnetic polycrystalline layer so as to form a magnetic polycrystalline layer, said third group of atoms including atoms of at least one non-magnetic element contained in the second non-magnetic polycrystalline layer; and
subjecting at least the second non-magnetic polycrystalline layer and the magnetic polycrystalline layer to heat treatment.

10. The method according to claim 9, wherein the first, the second and the third groups of atoms exit as an alloy containing Co and Cr.

11. The method according to claim 9, wherein a vacuum condition is kept during a period from deposition of the first group of atoms until completion of the heat treatment.

12. A method of making a multilayered structure film, comprising:
depositing a first group of atoms on a surface of an object;
subjecting the first group of atoms to heat treatment so as to form a first non-magnetic polycrystalline layer;
depositing a second group of atoms on a surface of the first non-magnetic polycrystalline layer so as to form a second non-magnetic polycrystalline layer having a thickness larger than thickness of the first non-magnetic polycrystalline layer, said second group of atoms including atoms of at least one element contained in the first non-magnetic polycrystalline layer;
depositing a third group of atoms on a surface of the second non-magnetic polycrystalline layer so as to form a first magnetic polycrystalline layer, said third group of atoms including atoms of at least one non-magnetic element contained in the second non-magnetic polycrystalline layer;
depositing a fourth group of atoms on a surface of the first magnetic polycrystalline layer;
subjecting the fourth group of atoms to heat treatment so as to form a third non-magnetic polycrystalline layer;
depositing a fifth group of atoms on a surface of the third non-magnetic polycrystalline layer so as to form a fourth non-magnetic polycrystalline layer having a thickness larger than thickness of the third non-magnetic polycrystalline layer, said fifth group of atoms including atoms of at least one element contained in the third non-magnetic polycrystalline layer;
depositing a sixth group of atoms on a surface of the fourth non-magnetic polycrystalline layer so as to form a second magnetic polycrystalline layer, said sixth group of atoms including atoms of at least one non-magnetic element contained in the fourth non-magnetic polycrystalline layer; and
subjecting at least the fourth non-magnetic polycrystalline layer and the second magnetic polycrystalline layer to heat treatment.

13. The method according to claim 12, wherein the first to sixth groups of atoms exit as an alloy containing Co and Cr.

14. The method according to claim 12, wherein a vacuum condition is kept during a period from deposition of the first group of atoms until completion of the heat treatment to the fourth non-magnetic polycrystalline layer and the second magnetic polycrystalline layer.
